(19) United States
(12) Patent Application Publication
(10) Pub. No.: US 2014/0293652 A1
(43) Pub. Date: Oct. 2, 2014

(54) LIGHT GUIDE PLATE AND MOLD FOR MANUFACTURING SAME

(71) Applicant: HON HAI PRECISION INDUSTRY CO. LTD., New Taipei (TW)

(72) Inventor: CHEN-HAN LIN, New Taipei (TW)

(73) Assignee: HON HAI PRECISION INDUSTRY CO., LTD., New Taipei (TW)

(21) Appl. No.: 13/953,945

(22) Filed: Jul. 30, 2013

(30) Foreign Application Priority Data
Mar. 27, 2013 (TW) 102111019

(51) Int. Cl. F21V 8/00; B29D 11/00

(52) U.S. Cl. CPC G02B 6/0036; B29D 11/00663
USPC 362/619; 249/187.1

(57) ABSTRACT

A light guide plate includes a rough light emitting surface, a bottom surface opposite to the light emitting surface, and a plurality of microstructures formed on the bottom surface. A cross-sectional surface of each of the microstructures is trapezoidal shaped.

### BACKGROUND

1. Technical Field

The present disclosure relates to a light guide plate and a mold for manufacturing the light guide plate.

2. Description of Related Art

A light guide plate includes a light emitting surface and a bottom surface opposite to the light emitting surface. A number of microstructures are formed on the bottom surface. The microstructures are used to change transmission direction of light and make the light emit from the light emitting surface. Yet, light reflected by the microstructures is directional, which makes bright-and-dark strips appear on the light emitting surface.

Therefore, it is desirable to provide a light guide plate and a mold of manufacturing the light guide plate which can overcome or at least alleviate the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, sectional view of a light guide plate according to a first embodiment of the present disclosure.

FIG. 2 is a schematic, sectional view of a mold for manufacturing a light guide plate according to a second embodiment of the present disclosure.

### DETAILED DESCRIPTION

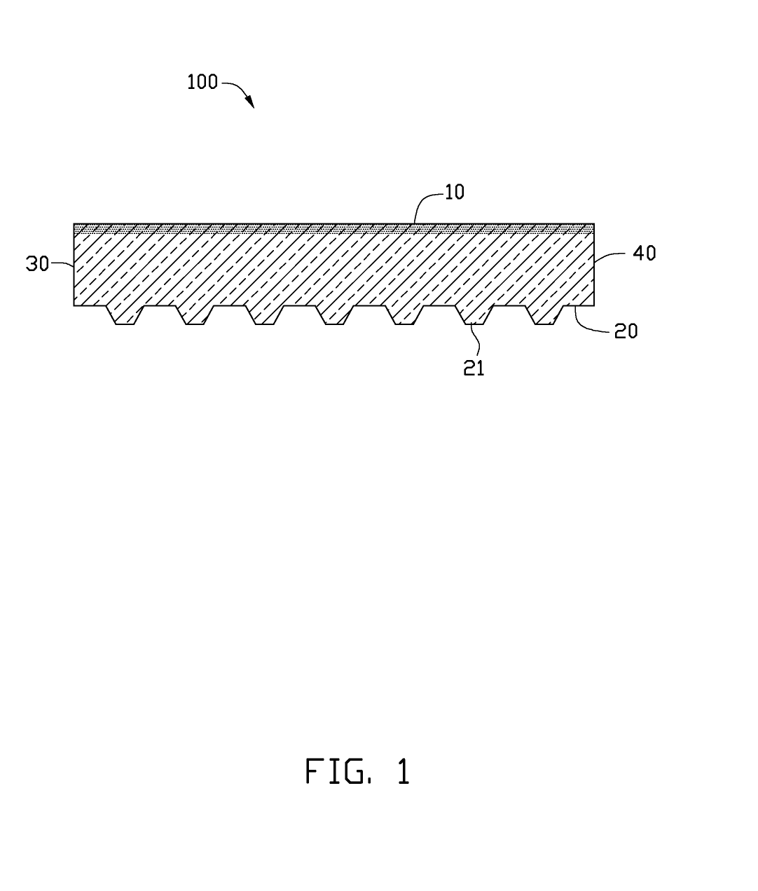

FIG. 1 shows a light guide plate 100 according to a first embodiment of the present disclosure. The light guide plate 100 includes a light emitting surface 10, a bottom surface 20 opposite to the light emitting surface 10, a light incident surface 30 and a side surface 40. The light incident surface 30 and the side surface 40 connect the light emitting surface 10 to the bottom surface 20. The light incident surface 30 is opposite to the side surface 30. The light guide plate 100 is made of transparent resin, such as polymethyl methacrylate (PMMA).

The light incident surface 30 faces a light source. Light emitting from the light source enters the light guide plate 100 from the light incident surface 30, and is transmitted towards the side surface 40 by means of total reflection. A number of microstructures 21 are formed on the bottom surface 20. In this embodiment, the microstructures 21 project from the bottom surface 20. The microstructures 21 are used to change the transmission direction of the light, thus destroying the condition of total reflection occurring at the light emitting surface 10, and make the light transmitted to the microstructures 21 emit out from the light emitting surface 10. In this embodiment, a cross-sectional surface of each of the microstructures 21 is trapezoidal shaped. The microstructures 21 are spaced apart from each other. Compared with dome-shaped microstructures, the trapezoidal shaped microstructures 21 allow more light to emit from the light emitting surface 10, thus increasing the brightness of the light guide plate 100.

For eliminating bright-and-dark strips appearing on the light emitting surface 10, the whole light emitting surface 10 is rough. Light arriving to the rough light emitting surface 10 will scatter in all directions to eliminate the bright-and-dark strips. In this way, the brightness of the light emitting surface 10 is uniform.

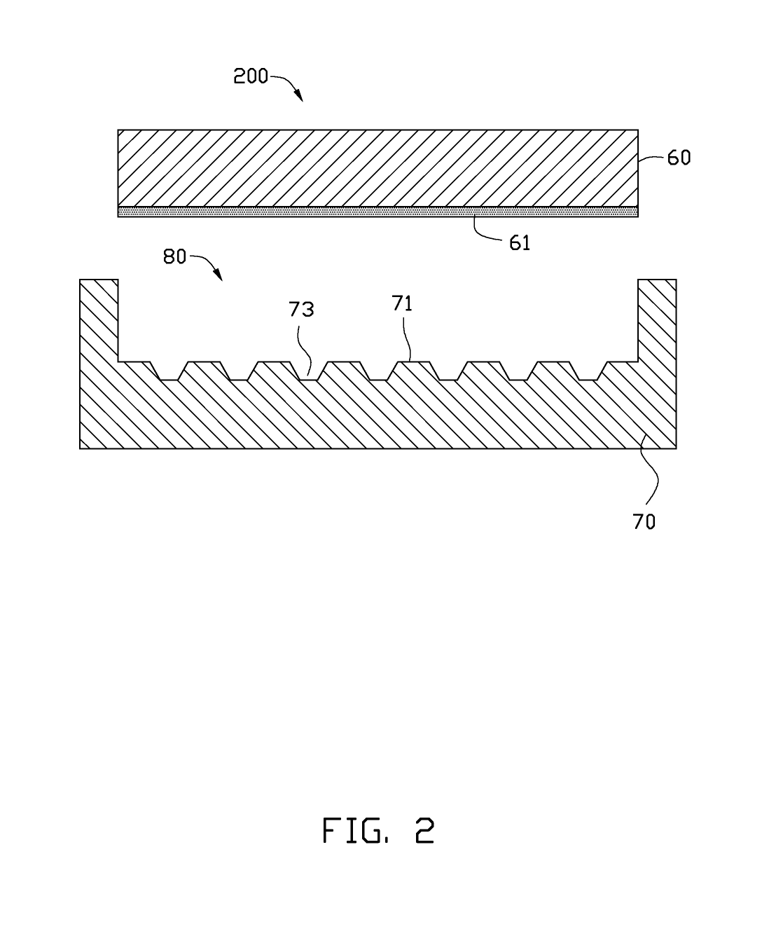

FIG. 2 shows a mold 200 for manufacturing the light guide plate 100. The mold 200 includes a first insert 60 and a second insert 70. The first insert 60 is a core insert, and the second insert 70 is a cavity insert. The first insert 60 and the second insert 70 cooperatively form a molding cavity 80 for forming the light guide plate 100.

The first insert 60 includes an inner surface 61 facing the molding cavity 80. The whole inner surface 61 is rough for forming the rough light emitting surface 10. The rough inner surface 61 is achieved by means of grinding or sand-blasting.

The second insert 70 includes an inner surface 71 facing the molding cavity 80. The inner surface 71 defines micro-recesses 73 for forming the microstructures 21.

The micro-recesses 73 are spaced apart from each other. A cross-sectional surface of each of the micro-recesses 73 is trapezoidal shaped. The micro-recesses 73 are machined by a diamond knife.

When manufacturing, melted material flows into the molding cavity 80. Then the melted material is cooled in the molding cavity 80 to form the light guide plate 100.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A light guide plate comprising:
a rough light emitting surface;
a bottom surface opposite to the light emitting surface; and
a plurality of microstructures on the bottom surface, a cross-sectional surface of each of the microstructures being trapezoidal shaped.

2. The light guide plate of claim 1, comprising a light incident surface connecting the light emitting surface to the bottom surface.

3. The light guide plate of claim 2, comprising a side surface connecting the light emitting surface to the bottom surface and opposite to the light incident surface.

4. The light guide plate of claim 1, wherein the light guide plate is made of transparent material.

5. The light guide plate of claim 4, wherein the light guide plate is made of transparent resin.

6. The light guide plate of claim 1, wherein the microstructures project from the bottom surface and spaced apart from each other.

7. A mold for manufacturing a light guide plate, comprising:
a first inset; and
a second insert for cooperatively with the first insert to form a molding cavity;
wherein the first insert comprises a first inner surface facing the molding cavity, the first inner surface is rough, the second insert comprises a second inner surface facing the molding cavity, the second inner surface defines a plurality of micro-recesses, and a cross-sectional surface of each of the micro-recesses is trapezoidal shaped.

8. The mold of claim 7, wherein the micro-recesses are machined by a diamond knife.

9. The mold of claim 7, wherein the rough first inner surface is achieved by grinding.

10. The mold of claim 7, wherein the rough first inner surface is achieved by sand-blasting.
